(19) United States
(12) Patent Application Publication
(10) Pub. No.: US 2026/0051564 A1
(43) Pub. Date: Feb. 19, 2026

(54) Battery Rack and Energy Storage System

(71) Applicant: SK On Co., Ltd., Seoul (KR)

(72) Inventors: Chan Ho Park, Seoul (KR); Byung Jun Park, Seoul (KR); Moo Han Baek, Seoul (KR); Yunn Young Lee, Seoul (KR)

(21) Appl. No.: 19/298,249

(22) Filed: Aug. 13, 2025

(30) Foreign Application Priority Data
Aug. 14, 2024 (KR) 10-2024-0108862

(51) Int. Cl. H01M 10/6556; H01M 10/613; H01M 10/6568; H01M 50/244

(52) U.S. Cl. CPC H01M 10/6556; H01M 10/613; H01M 10/6568; H01M 50/244

(57) ABSTRACT

Disclosed herein are a battery rack and an energy storage system. The battery rack includes a battery module and a rack housing that includes a plurality of horizontal frames and a plurality of vertical frames and accommodates the battery module. At least one of the vertical frames is a cooling frame. A flow path is formed and provided inside the cooling frame. A cooling fluid is supplied to the flow path through a first pipe. A second pipe is connected to the flow path to supply the cooling fluid to the battery module.

### CROSS-REFERENCE TO RELATED APPLICATION

This application claims priority to Korean Patent Application No. 10-2024-0108862 filed Aug. 14, 2024, the disclosure of which is hereby incorporated by reference in its entirety.

### BACKGROUND

### 1. Technical Field

The present disclosure relates to a battery rack and an energy storage system.

### 2. Technical Considerations

Secondary batteries are sometimes used alone but are often formed of a plurality of secondary batteries electrically connected in series and/or in parallel. For example, a plurality of secondary batteries may be accommodated inside a single module case while being electrically connected to each other to form a single battery module. In addition, the battery module may be used alone or two or more battery modules may be electrically connected in series and/or in parallel to each other to form a higher-level device such as a battery rack or a battery pack.

Recently, as issues such as power shortage and eco-friendly energy have risen in prominence, an energy storage system (ESS) for storing generated power has been receiving more attention. An ESS is a component for building a smart grid system. For example, in terms of power consumption, such as the demand for air conditioning in the summer, power consumption may not be constant and may fluctuate frequently, but in terms of supplying power, it is realistically difficult to match such power consumption even when power production is adjusted to some extent. An imbalance between power supply and consumption may lead to power oversupply or power undersupply, and a smart grid system may flexibly store and control power to solve such problems. In addition, the commercialization of electric vehicles has progressed in earnest in recent years, and ESSs can now be used in facilities for charging electric vehicles, such as charging stations.

These ESSs are typically formed to include a large number of battery containers. In addition, each battery container includes a plurality of battery racks, and each battery rack includes a plurality of battery modules.

### SUMMARY

The present disclosure is directed to providing a battery rack and an energy storage system (ESS).

The present disclosure is also directed to providing a battery rack that allows the number of components to be reduced and an ESS.

The present disclosure is also directed to providing a battery rack and an ESS that allow costs to be reduced.

The present disclosure is also directed to providing a battery rack that allows an occurrence rate of cooling fluid leakage to be reduced and an ESS.

The present disclosure is also directed to providing a battery rack that allows space utilization efficiency to be improved and an ESS.

Some non-limiting embodiments of the present disclosure can be widely applied in green technology fields such as battery charging stations, solar power generation using batteries, wind power generation, etc. In addition, some non-limiting embodiments of the present disclosure can be used in eco-friendly electric vehicles, hybrid vehicles, etc., to prevent climate change by suppressing air pollution and greenhouse gas emissions.

According to some non-limiting embodiments of the present disclosure, there is provided a battery rack including a battery module, a rack housing that includes a plurality of horizontal frames and a plurality of vertical frames and accommodates the battery module, wherein at least one of the vertical frames is a cooling frame, and a flow path is provided inside the cooling frame, a first pipe through which a cooling fluid is supplied to the flow path, and a second pipe connected to the flow path to supply the cooling fluid to the battery module.

In some non-limiting embodiments, the rack housing may include the horizontal frames and the vertical frames and include a plurality of frame assemblies disposed in a first horizontal direction, and each of the frame assemblies may include the plurality of vertical frames disposed in a second horizontal direction perpendicular to the first horizontal direction and the plurality of horizontal frames disposed in a vertical direction and coupled to side surfaces of the vertical frames in the first horizontal direction.

In some non-limiting embodiments, a space between the frame assemblies spaced apart in the first horizontal direction may be partitioned vertically by the horizontal frames, and the battery module may be accommodated in the partitioned space.

In some non-limiting embodiments, among the vertical frames of each frame assembly, a vertical frame at one end in the second horizontal direction may be the cooling frame.

In some non-limiting embodiments, the cooling frame may be extrusion-molded.

In some non-limiting embodiments, the cooling frame may include an inner wall provided with the flow path therein and an outer wall accommodating the inner wall.

In some non-limiting embodiments, the cooling frame may further include a rib that connects an outer surface of the inner wall and an inner surface of the outer wall.

In some non-limiting embodiments, the battery rack may further include a cover cap coupled to an upper end of the inner wall.

In some non-limiting embodiments, the cover cap may include an insertion portion inserted into the inner wall and a head supported on an upper surface of the inner wall.

In some non-limiting embodiments, the cover cap may not protrude further upward than the outer wall.

In some non-limiting embodiments, a height of an upper end of the inner wall may be lower than a height of an upper end of the outer wall.

In some non-limiting embodiments, the flow path may include a first flow path and a second flow path.

In some non-limiting embodiments, the cooling frame may be provided with a first communication hole that passes through the cooling frame and communicates with the first flow path, and a second communication hole connected to the second flow path.

In some non-limiting embodiments, nipples connected to the second pipe may be coupled to the first communication hole and the second communication hole.

In some non-limiting embodiments, the first communication hole and the second communication hole may be provided in both side surfaces of the cooling frame in the first horizontal direction.

In some non-limiting embodiments, the first communication hole and the second communication hole may be provided in one surface of the cooling frame in the second horizontal direction.

Meanwhile, an ESS according to non-limiting embodiments of the present disclosure may include a battery rack, as described herein.

In some non-limiting embodiments, the ESS may further include a chiller from which the cooling fluid is supplied to the first pipe.

In some non-limiting embodiments, the chiller may cool the cooling fluid.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

The above and other objects, features and advantages of the present disclosure will become more apparent to those of ordinary skill in the art by describing exemplary and non-limiting embodiments thereof in detail with reference to the accompanying drawings, in which:

FIG. 1 is a perspective view illustrating a battery rack according to some non-limiting embodiments according to the principles of the present disclosure;

FIG. 2 is a perspective view illustrating an arrangement structure of a battery module and a frame assembly shown in FIG. 1;

FIG. 3 is a front view illustrating the frame assembly shown in FIG. 1;

FIG. 4 is a perspective view illustrating a cooling frame shown in FIG. 1;

FIG. 5 is a cross-sectional view illustrating the cooling frame shown in FIG. 1;

FIG. 6 is a perspective view illustrating the cooling frame shown in FIG. 1; and

FIG. 7 is a perspective view illustrating a modified example of the cooling frame shown in FIG. 1.

### DETAILED DESCRIPTION

Hereinafter, the present disclosure will be described in detail with reference to the accompanying drawings. However, this is merely exemplary and the present disclosure is not limited to specific embodiments described as examples.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments of the disclosed subject matter. Hence, specific dimensions and other physical characteristics related to the embodiments disclosed herein are not to be considered as limiting.

No embodiment, aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms.

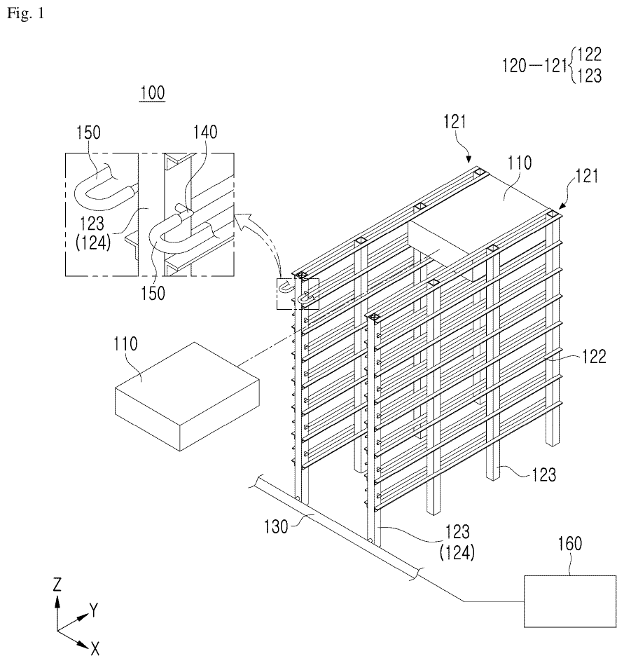

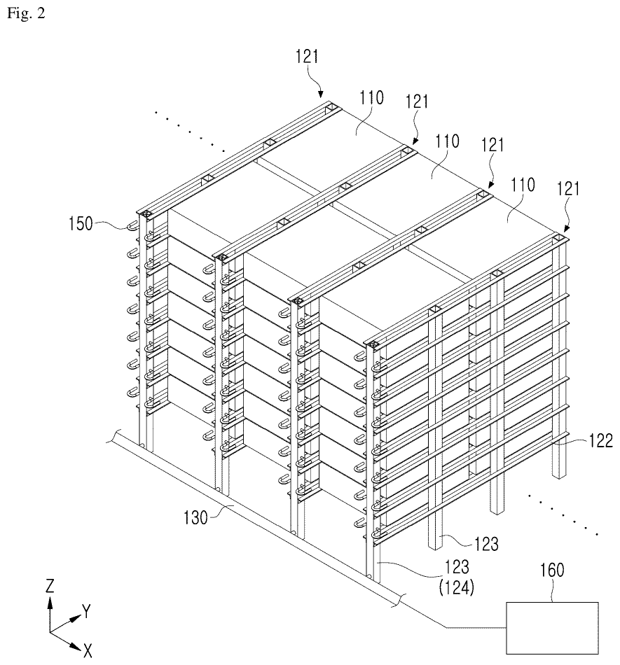

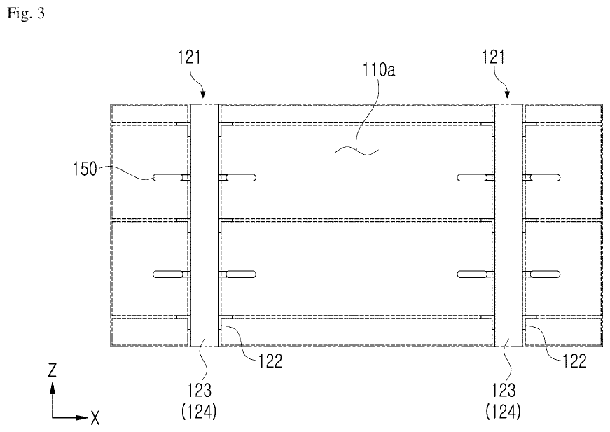

FIG. 1 is a perspective view illustrating a battery rack according to some non-limiting embodiments of the present disclosure. FIG. 2 is a perspective view illustrating an arrangement structure of a battery module and a frame assembly shown in FIG. 1. FIG. 3 is a front view illustrating the frame assembly shown in FIG. 1.

Hereinafter, for convenience of description, based on coordinate axes shown in FIG. 1 and the like, an x direction is referred to as a first horizontal direction, a y direction is referred to as a second horizontal direction, and a z direction is referred to as a vertical direction.

Referring to FIGS. 1 to 3, in some non-limiting embodiments, a battery rack 100, which includes a battery module 110, a plurality of horizontal frames 122 and a plurality of vertical frames 123 for accommodating the battery module 110, wherein at least one of the vertical frames 123 is a cooling frame 124, a rack housing 120 with a flow path 211 inside the cooling frame 124, a first pipe 130 that supplies a cooling fluid to the flow path 211, and a second pipe 150 that is connected to the flow path 211 and supplies the cooling fluid to the battery module 110, may be provided.

In addition, in some non-limiting embodiments, an energy storage system (ESS) including the battery rack 100 may be provided.

In some non-limiting embodiments, the rack housing 120 may include the plurality of horizontal frames 122 and the plurality of vertical frames 123. The vertical frames 123 are disposed in the second horizontal direction, and the horizontal frames 122 may be coupled on both sides in the first horizontal direction of the vertical frames 123 in a vertical direction. A space into which the battery module 110 is inserted is provided between the horizontal frame 122 and the vertical frame 123, which are orthogonal to each other, and the battery module 110 may be loaded in the rack housing 120. In FIG. 1, only an appropriate number of the horizontal frames 122 and the vertical frames 123 for convenience of illustration and understanding are shown, and the battery module 110 is also shown in a simplified form. As will be described in detail below, in FIG. 2, a state in which frame assemblies 121 including the plurality of horizontal frames 122 and the plurality of vertical frames 123 are arranged in the first horizontal direction, and the battery modules 110 are loaded in the disposed frame assemblies 121. The arrangement direction and number of the horizontal frames 122 and the vertical frames 123 are not limited to the examples shown in the drawings.

In some non-limiting embodiments, at least one of the vertical frames 123 may be the cooling frame 124 in which the flow path 211 is provided. For example, among the vertical frames 123 forming a plurality of rows, the vertical frames 123 disposed first (or last) may be the cooling frames 124 with flow paths 211 provided therein.

In some non-limiting embodiments, the rack housing 120 may include the plurality of frame assemblies 121 including the horizontal frames 122 and the vertical frames 123 and disposed in the first horizontal direction, and each frame assembly 121 may include the plurality of vertical frames 123 disposed in the second horizontal direction perpendicular to the first horizontal direction and the plurality of horizontal frames 122 disposed in the vertical direction and coupled to side surfaces of the vertical frames 123 in the first horizontal direction. Each frame assembly 121 may include the plurality of vertical frames 123 disposed in the second horizontal direction, i.e., the y direction. In addition, each frame assembly 121 may include the plurality of horizontal frames 122 disposed in the vertical direction, i.e., the z direction, and the horizontal frames 122 may be coupled to the side surfaces of the vertical frames 123.

In some non-limiting embodiments, a space between the frame assemblies 121 spaced apart in the first horizontal direction is partitioned vertically by the horizontal frames 122, and the battery module 110 can be accommodated in the partitioned space (see 110a). The horizontal frames 122 are provided on facing surfaces of the vertical frames 123 disposed in the first horizontal direction, and the battery module 110 may be accommodated in the space (see 110a) partitioned in the vertical direction and the first horizontal direction by the horizontal frames 122 and the vertical frames 123.

In some non-limiting embodiments, among the vertical frames 123 of each frame assembly 121, the vertical frame 123 in the second horizontal direction may be the cooling frame 124. That is, among the plurality of vertical frames 123 disposed of each frame assembly 121 in the second horizontal direction, i.e., the y direction, the first or last vertical frame 123 may be the cooling frame 124. A non-limiting embodiment in which the first vertical frame 123 is the cooling frame 124 is shown in the drawing. Since the first or last vertical frame 123 in each frame assembly 121 is provided as the cooling frame 124, the first pipe 130 and the cooling frame 124 may be easily connected.

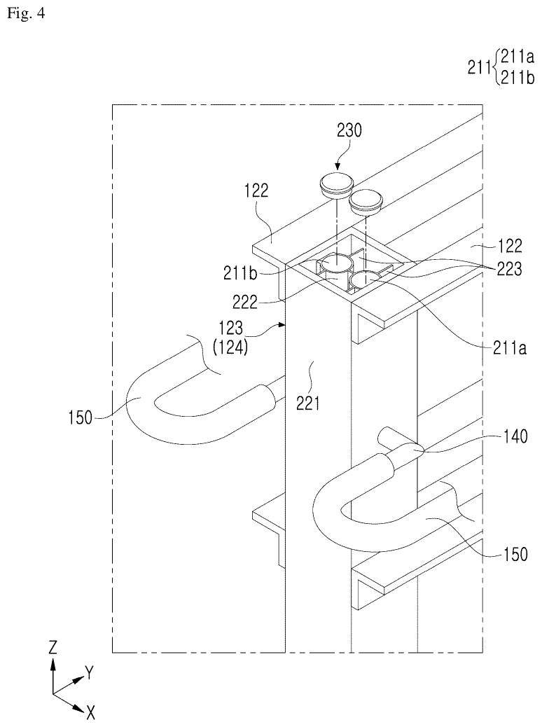

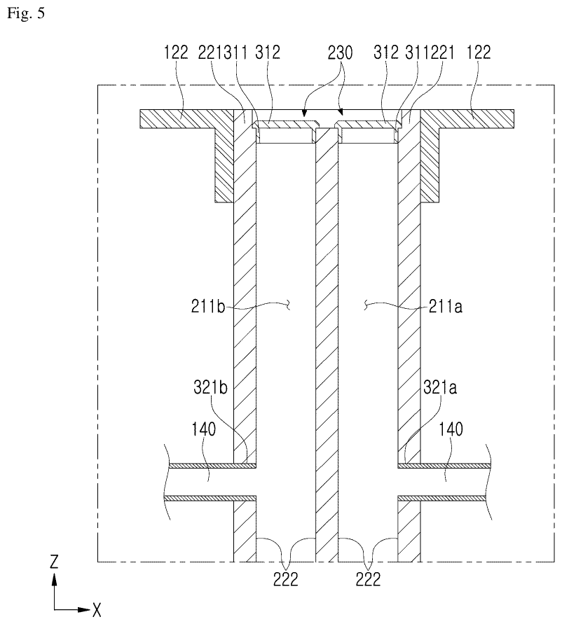

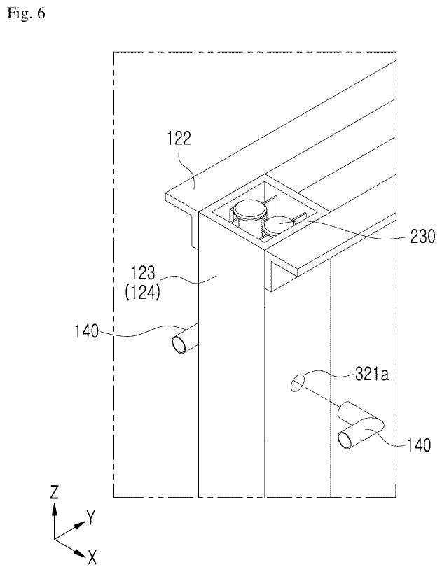

FIG. 4 is a perspective view illustrating a cooling frame shown in FIG. 1. FIG. 5 is a cross-sectional view illustrating the cooling frame shown in FIG. 1. FIG. 6 is a perspective view illustrating the cooling frame shown in FIG. 1.

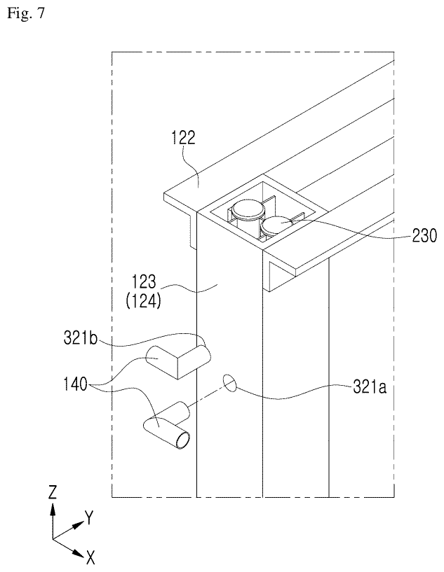

Referring to FIGS. 4 to 6, in some non-limiting embodiments, the first pipe 130 and the second pipe 150 may be connected through the flow path 211 provided inside the cooling frame 124. The flow path 211 may be provided inside the cooling frame 124 from a lower end to an upper end of the cooling frame 124. As will be described in detail below, the first pipe 130 may be coupled to a lower or upper portion of the cooling frame 124 to be connected to the flow path 211. The cooling fluid is introduced into the flow path 211 through the first pipe 130, that is, the cooling fluid may be introduced from a lower side of the flow path 211. The cooling fluid introduced into the flow path 211 is supplied to the battery module 110 through the second pipe 150. The second pipe 150 may be connected to a nipple 140 which is connected to the cooling frame 124 and connected to the flow path 211. A plurality of communication holes 321 may be provided in the cooling frame 124 to be connected to the flow path 211 in the vertical direction, and the nipple 140 may be connected to the communication holes 321. The communication holes 321 may be provided in both sides of the cooling frame 124 in the first horizontal direction (see FIG. 6) or on one side in the second horizontal direction (see FIG. 7). Meanwhile, a non-limiting embodiment in which the second pipe 150 is connected to only some of a plurality of nipples 140 connected to the cooling frame 124 is shown in FIG. 1. This is only for convenience of illustration, and the second pipe 150 may be connected to all the nipples 140.

In some non-limiting embodiments, the first pipe 130 may be coupled to the cooling frame 124 and connected to the flow path 211. For example, the first pipe 130 is coupled to the lower end or upper end of the cooling frame 124, and the cooling fluid may be supplied from a chiller (see reference numeral 160) to the flow path 211 inside the cooling frame 124 through the first pipe 130. Although the first pipe 130 is coupled to the lower end of the cooling frame 124 in the drawing, the first pipe 130 may also be coupled to the upper end of the cooling frame 124. The first pipe 130 may be coupled to one or more cooling frames 124, and a non-limiting embodiment in which the first pipe 130 is coupled to the two cooling frames 124 to supply the cooling fluid is shown in the drawing. The cooling fluid is not limited to a fluid supplied from the chiller for cooling the battery module 110 and may be, for example, cooling water.

In some non-limiting embodiments, the second pipe 150 may be connected to the flow path 211 to supply the cooling fluid to the battery module 110. As will be described in detail below, the cooling frame 124 may be provided with the communication hole 321 which passes through the cooling frame 124 and communicates with the flow path 211 and to which the second pipe 150 is connected (see FIG. 5). The communication hole 321 may be provided to pass through inner and outer surfaces of the cooling frame 124, and for example, to pass through an outer wall 221 and an inner wall 222 of the cooling frame 124. The nipple 140 may be coupled to the communication hole 321, and the flow path 211 and the second pipe 150 may be connected through the nipple 140.

In the drawing, a form in which the second pipe 150 is connected to the battery module 110 is omitted. The battery module 110 includes pipes and flow paths for cooling battery cells (not shown), and one end of the second pipe 150 may be appropriately connected to the pipes and the flow paths of the battery module 110.

In some non-limiting embodiments, the flow path 211 may be provided inside the cooling frame 124 to connect the first pipe 130 and the second pipe 150. Since the flow path 211 connecting the first pipe 130 and the second pipe 150 is provided inside the cooling frame 124, the external exposure of the pipe and the flow paths for supplying the cooling fluid from the chiller to the battery module 110 may be minimized. In other words, there is no need to separately manufacture and assemble components for connecting the first pipe 130 and the second pipe 150, and thus the number of parts can be decreased and costs can be reduced.

In some non-limiting embodiments, since the flow path 211 connecting the first pipe 130 and the second pipe 150 is provided inside the cooling frame 124, the probability of cooling fluid leakage at a pipe connection portion can be reduced. For example, when the battery module 110 is loaded in or unloaded from the rack housing 120, there is a high probability of collision between the battery module 110 and the pipes, and the pipes may be damaged due to such collision. However, according to the present disclosure, since the flow path 211 is provided inside the cooling frame 124 and the external exposure of the pipes for supplying the cooling fluid to the battery module 110 is minimized, the probability of pipe damage and cooling fluid leakage during loading and unloading of the battery module 110 can be reduced.

In some non-limiting embodiments, since the flow path 211 connecting the first pipe 130 and the second pipe 150 is provided inside the cooling frame 124, the exposure of pipes to the outside is minimized, which can improve space utilization efficiency of the entire system.

In some non-limiting embodiments, the cooling frame 124 may be extrusion-molded. That is, the cooling frame 124 may be integrally extrusion-molded, including the flow path 211 provided therein. The flow path 211 may be provided from the lower end to the upper end in a longitudinal direction of the cooling frame 124. As will be described below, the cooling frame 124 may be extrusion-molded to the outer wall 221, a rib 223 provided inside the outer wall 221, and the inner wall 222 with the flow path 211 provided therein and therefore can be easily manufactured.

In some non-limiting embodiments, the cooling frame 124 may include the inner wall 222 with the flow path 211 provided therein and the outer wall 221 accommodating the inner wall 222. The inner wall 222 and the outer wall 221 are connected, and the outer wall 221 may have a quadrangular pillar shape as the overall shape of the cooling frame 124.

In some non-limiting embodiments, the cooling frame 124 may further include the rib 223 connecting an outer surface of the inner wall 222 and an inner surface of the outer wall 221. The rib 223 may connect the inner wall 222 and the outer wall 221 to reinforce rigidity of the cooling frame 124. The inner wall 222 may be directly connected to the outer wall 221 from the side or may be connected to the outer wall 221 through the rib 223.

In some non-limiting embodiments, the battery rack 100 according to the present disclosure may further include a cover cap 230 coupled to an upper or lower end of the inner wall 222. The cover cap 230 may be coupled to cover an opening of the inner wall 222 at the upper or lower end of the cooling frame 124. That is, the lower (or upper) end of the flow path 211 that is extrusion-molded may be connected to the first pipe 130, and the upper end and the lower end of the flow path 211 may be blocked by the cover cap 230. An O-ring or the like that seals the coupling of the cover cap 230 may be additionally provided. Alternatively, the cover cap 230 may be welded and bonded to the flow path 211 and sealed.

In some non-limiting embodiments, the cover cap 230 may include an insertion portion 311 inserted into the inner wall 222 and a head 312 supported on an upper or lower surface of the inner wall 222. The insertion portion 311 is provided to have a relatively small diameter and may be inserted into the inner wall 222 and come into close contact with the inner surface of the inner wall 222. The head 312 is not inserted into the inner wall 222, but is supported on the upper or lower surface of the inner wall 222, and may limit a depth to which the cover cap 230 is inserted.

In some non-limiting embodiments, the cover cap 230 may not be exposed to the outside of the outer wall 221. In some non-limiting embodiments, a height of the upper end of the inner wall 222 may be lower than that of the upper end of the outer wall 221. By providing the upper end of the inner wall 222 at a lower height than the upper end of the outer wall 221, the cover cap 230 supported on the upper surface of the inner wall 222 may be located at a lower position than the outer wall 221. Similarly, since the lower end of the inner wall 222 is provided to be inserted upward more than the lower end of the outer wall 221, the cover cap 230 supported on the lower surface of the inner wall 222 may be located at a higher position than the outer wall 221. Accordingly, the cover cap 230 may not be exposed to the outside of the outer wall 221, and the cover cap 230 may be prevented from being separated from the cooling frame 124 due to interference with surrounding components, thereby securing safety.

In some non-limiting embodiments, the flow path 211 may include a first flow path 211a and a second flow path 211b. The first flow path 211a and the second flow path 211b may be provided as double rows inside the cooling frame 124. In some non-limiting embodiments, a space into which the battery module 110 is inserted is provided on each side of the cooling frame 124, and the cooling fluid may be supplied to the battery module 110 on one side through the first flow path 211a and to the battery module 110 on the other side through the second flow path 211b. Alternatively, in some non-limiting embodiments, a cooling fluid cooled in the chiller 160 may be supplied to the battery module 110 through the first flow path 211a, and the cooling fluid used to cool the battery module 110 may be recovered through the second flow path 211b. The cooling fluid recovered through the second flow path 211b may be discharged to the outside or re-supplied to the chiller 160, cooled, supplied to the first flow path 211a again, and then circulated.

In some non-limiting embodiments, the cooling frame 124 may be provided with a first communication hole 321a that passes through the cooling frame 124 and communicates with the first flow path 211a, and a second communication hole 321b that communicates with the second flow path 211b. The first communication hole 321a and the second communication hole 321b may be respectively provided to pass through the outer wall 221 and the inner wall 222. The first flow path 211a may be connected to the second pipe 150 through the first communication hole 321a, and the second flow path 211b may be connected to the second pipe 150 through the second communication hole 321b.

In some non-limiting embodiments, the nipples 140 connected to the second pipe 150 may be coupled to the first communication hole 321a and the second communication hole 321b. The first communication hole 321a and the second communication hole 321b may each be connected to the second pipe 150 through the nipples 140. Although some embodiments may include a nipple 140 having a substantially L-shaped shape (e.g., as shown in the drawing), the shape of the nipple 140 is not limited thereto, and it is sufficient when the nipple 140 has a shape that can easily connect the first and second communication holes 321a and 321b to the second pipe 150.

In some non-limiting embodiments, the nipple 140 may be welded to the cooling frame 124. One end of the nipple 140 may be provided to be inserted into the first communication hole 321a or the second communication hole 321b, and the nipple 140 may be welded to the cooling frame 124 while an end portion of the nipple 140 is inserted into the communication hole. A coupling method between the nipple 140 and the cooling frame 124 is not limited, and when coupled by welding, it can be easily coupled and can also prevent leakage of the cooling fluid with high airtightness.

In some non-limiting embodiments, the first communication hole 321a and the second communication hole 321b may be provided in both side surfaces of the cooling frame 124 in the first horizontal direction. That is, the first and second communication holes 321a and 321b may be provided on one side surface and the other side surface of the cooling frame 124 coupled to the horizontal frames 122.

FIG. 7 is a perspective view illustrating a modified example of the cooling frame shown in FIG. 1.

Referring to FIG. 7, in some non-limiting embodiments, the first communication hole 321a and the second communication hole 321b may be provided in one surface of the cooling frame 124 in the second horizontal direction. As shown in the drawing, the first and second communication holes 321a and 321b may be provided on the outer surface of the cooling frame 124 in the second horizontal direction.

As described above, according to some non-limiting embodiments of the present disclosure, the battery rack and the ESS can be provided.

In addition, according to some non-limiting embodiments of the present disclosure, a battery rack that allows the number of components to be reduced and an ESS can be provided.

In addition, according to some non-limiting embodiments of the present disclosure, a battery rack and ESS that allow costs to be reduced can be provided.

In addition, according to some non-limiting embodiments of the present disclosure, a battery rack that allows an occurrence rate of cooling fluid leakage to be reduced and an ESS can be provided.

In addition, according to some non-limiting embodiments of the present disclosure, a battery rack that allows space utilization efficiency to be improved and an ESS can be provided.

The content described above is merely an example of applying the principle of the present disclosure, and other configurations may be further included without departing from the scope of the present disclosure. For example, although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A battery rack comprising:
a battery module;
a rack housing comprising a plurality of horizontal frames and a plurality of vertical frames for accommodating the battery module, wherein at least one of the vertical frames is a cooling frame, and wherein a flow path is provided inside the cooling frame;
a first pipe through which a cooling fluid is supplied to the flow path; and
a second pipe connected to the flow path to supply the cooling fluid to the battery module.

2. The battery rack of claim 1, wherein:
the rack housing comprises the horizontal frames and the vertical frames and comprises a plurality of frame assemblies disposed in a first horizontal direction; and
each of the frame assemblies comprises the plurality of vertical frames disposed in a second horizontal direction perpendicular to the first horizontal direction and the plurality of horizontal frames disposed in a vertical direction and coupled to side surfaces of the vertical frames in the first horizontal direction.

3. The battery rack of claim 2, wherein a space between the frame assemblies spaced apart in the first horizontal direction is partitioned vertically by the horizontal frames, and the battery module is accommodated in the partitioned space.

4. The battery rack of claim 2, wherein, among the vertical frames of each frame assembly, a vertical frame at one end in the second horizontal direction is the cooling frame.

5. The battery rack of claim 1, wherein the cooling frame is extrusion-molded.

6. The battery rack of claim 1, wherein the cooling frame comprises an inner wall provided with the flow path therein and an outer wall accommodating the inner wall.

7. The battery rack of claim 6, wherein the cooling frame further comprises a rib that connects an outer surface of the inner wall and an inner surface of the outer wall.

8. The battery rack of claim 6, further comprising a cover cap coupled to an end portion of the inner wall.

9. The battery rack of claim 8, wherein the cover cap comprises an insertion portion inserted into the inner wall and a head supported on an upper or lower surface of the inner wall.

10. The battery rack of claim 8, wherein the cover cap does not protrude further upward or downward than the outer wall.

11. The battery rack of claim 8, wherein a height of an upper end of the inner wall is lower than a height of an upper end of the outer wall.

12. The battery rack of claim 1, wherein the flow path comprises a first flow path and a second flow path.

13. The battery rack of claim 12, wherein the cooling frame is provided with a first communication hole that passes through the cooling frame and communicates with the first flow path, and a second communication hole connected to the second flow path.

14. The battery rack of claim 13, wherein nipples connected to the second pipe are coupled to the first communication hole and the second communication hole.

15. The battery rack of claim 14, wherein the nipples are welded to the cooling frame.

16. The battery rack of claim 13, wherein the first communication hole and the second communication hole are provided in both side surfaces of the cooling frame in the first horizontal direction.

17. The battery rack of claim 13, wherein the first communication hole and the second communication hole are provided in one surface of the cooling frame in the second horizontal direction.

18. An energy storage system comprising:
a battery rack comprising:
a battery module;
a rack housing comprising a plurality of horizontal frames and a plurality of vertical frames for accommodating the battery module, wherein at least one of the vertical frames is a cooling frame, and wherein a flow path is provided inside the cooling frame;
a first pipe through which a cooling fluid is supplied to the flow path; and
a second pipe connected to the flow path to supply the cooling fluid to the battery module.

19. The energy storage system of claim 18, further comprising a chiller from which the cooling fluid is supplied to the first pipe.

20. The energy storage system of claim 19, wherein the chiller cools the cooling fluid.
